(19) United States
(12) Patent Application Publication
(10) Pub. No.: US 2005/0280185 A1
(43) Pub. Date: Dec. 22, 2005

(54) Methods and apparatus for 3D printing

(75) Inventors: David Russell, Burlington, MA (US); Andres Hernandez, Malden, MA (US); Joshua Kinsley, Arlington, MA (US); Andrew Berlin, Gloucester, MA (US)

Correspondence Address: GOODWIN PROCTER LLP;PATENT ADMINISTRATOR, EXCHANGE PLACE, BOSTON, MA, 02109-2881, US

(73) Assignee: Z Corporation, Burlington, MA (US)

(21) Appl. No.: 11/097,987

(22) Filed: Apr. 1, 2005

Related U.S. Application Data
(60) Provisional application No. 60/558,940, filed on Apr. 2, 2004.

(51) Int. Cl. B29C 41/02

(52) U.S. Cl. 264/308; 425/375

(57) ABSTRACT

The invention relates to methods and apparatus for fabricating a three-dimensional object from a representation of the object stored in memory. The apparatus includes a stationary build table for receiving successive layers of a build material and at least one movable printhead disposed above the build table. The printhead deposits a binding material in a predetermined pattern on each successive layer of the build material to form the three-dimensional object.

### CROSS-REFERENCE TO RELATED APPLICATION

This application incorporates by reference, and claims priority to and the benefit of, U.S. Provisional Patent Application Ser. No. 60/558,940, which was filed on Apr. 2, 2004.

### FIELD OF THE INVENTION

This invention relates generally to rapid prototyping techniques and, more particularly, to a prototyping machine for fabricating large parts by 3D printing.

### BACKGROUND

The field of rapid prototyping involves the production of prototype articles and small quantities of functional parts, as well as structural ceramics and ceramic shell molds for metal casting, directly from computer-generated design data.

Two well-known methods for rapid prototyping include a selective laser sintering process and a liquid-binder 3D printing process. These techniques are similar, to the extent that they both use layering techniques to build three-dimensional articles. Both methods form successive thin cross-sections of the desired article. The individual cross-sections are formed by bonding together adjacent grains of a granular material on a generally planar surface of a bed of the granular material. Each layer is bonded to a previously formed layer to form the desired three-dimensional article at the same time as the grains of each layer are bonded together. The laser-sintering and liquid-binder techniques are advantageous, because they create parts directly from computer-generated design data and can produce parts having complex geometries. Moreover, 3D printing can be quicker and less expensive than machining of prototype parts or production of cast or molded parts by conventional “hard” or “soft” tooling techniques that can take from a few weeks to several months to complete, depending on the complexity of the item.

3D printing has been used to make ceramic molds for investment casting, to produce fully functional cast metal parts. 3D printing may also be useful in design-related fields for visualization and demonstration, and in fields where it is desirable to create mechanical prototypes. It may also be useful for making patterns for molding processes.

An early 3D printing technique, described in U.S. Pat. No. 5,204,055 to Sachs et al., the disclosure of which is hereby incorporated by reference herein in its entirety, describes the use of an inkjet style printing head to deliver a liquid or colloidal binder material to sequentially applied layers of powdered material. The 3D inkjet printing technique or liquid-binder method involves applying a layer of a powdered material to a surface using a counter-rotating roller. Using the counter-rotating roller allows thin layers of material to be spread relatively evenly, without disturbing previous layers. After the powdered material is applied to the surface, the inkjet printhead delivers a liquid binder in a predetermined pattern to the layer of powder. The binder infiltrates and interacts with the powder, causing the layer to solidify in the printed areas by, for example, activating an adhesive in the powder. The binder also penetrates into the underlying layer, producing interlayer bonding. After the first cross-sectional portion is formed, the previous steps are repeated, building successive cross-sectional portions until the final article is formed.

Typically, a vertically travelling build table is used to support the article as it is being formed. After each successive layer of powder and liquid binder is applied, the build table travels downwardly by the incremental thickness of the new layer to be applied. Such build tables are disclosed in U.S. Pat. Nos. 5,902,441 to Bredt et al. and 6,375,874 to Russell et al., the disclosures of which are hereby incorporated by reference herein in their entirety. Typically, these build tables are suitable for the fabrication of relatively small parts having a cross-sectional size limit less than about the maximum dimensions of the build table.

Sometimes, however, it is desirable to fabricate large parts and prototypes, for instance, for the automotive or architectural industries. Such parts can include casting molds and cores. When building an article that is relatively large, for instance, from the size of a computer monitor housing to the size of a car or larger, traditional 3D printing technologies are unable to accommodate the size and the weight of the part being produced. Therefore, there is a need for a printer that can form large three-dimensional objects.

### SUMMARY

The present invention is directed to an apparatus and method for printing a large three-dimensional object, such as a mold for a car engine block, from a representation of the object that is stored in the memory of a computer. The apparatus of the invention includes a stationary build table, along with supporting material supply systems that facilitate the manufacturing of large objects.

In one aspect, the invention relates to an apparatus for fabricating a three-dimensional object from a representation of the object stored in memory. The apparatus includes a stationary build table for receiving successive layers of a build material and at least one printhead disposed above the build table for selectively applying binder.

In various embodiments, the printhead is primarily movable in at least two directions within, for example, a three dimensional space above the build table. The apparatus can include a subsystem for moving the printhead in a vertical direction, such as at least one jack post for supporting the gantry, the jack post including a lead screw, a lead screw nut, and a motor for driving the lead screw. Encoders can also be included for determining positions of the lead screw and/or nut. The apparatus can also include a gantry for moving the printhead in a first horizontal direction. In one embodiment, a carriage is also included for moving the printhead in a second horizontal direction. The gantry can be positioned in the first horizontal position by at least one motor-driven belt or by at least one motor-driven lead screw. The carriage can be positioned in the second horizontal position by at least one motor-drive belt or by at least one motor-driven lead screw.

In various embodiments, the apparatus includes an enclosure disposed about the stationary build table. An air handling system can also be included, the air handling system including at least one air intake port disposed through a wall of the enclosure and an exhaust system in communication with an interior area of the enclosure for drawing air out of the enclosure. The air handling system can also include a particulate filtration subsystem.

In other embodiments, the apparatus includes a subsystem for supplying powdered build material to the build table. For instance, a build material delivery system that includes a storage means (e.g., a container) for holding the build material and a conveying subsystem for delivering the build material to the build table can be included. The build material delivery system can also include at least two storage chambers for holding at least two build material components separate from each other and a blender for mixing the build material components in a predetermined ratio for delivery to the build table.

The apparatus can also include a build material dispensing system. The build material dispensing system includes a trough for receiving the build material, where the trough is mounted on a gantry capable of traversing at least a portion of the build table, and a metering subsystem for dispensing the build material. In one embodiment, a delivery dimension of the build material dispensing system is adjustable to correspond to a width of a predetermined build volume. The apparatus can also include a spreading subsystem for distributing the dispensed build material evenly to form a layer. The spreading subsystem can include a range of travel adjustable to correspond to a length of a predetermined build volume. In another embodiment, a sensor can be included for determining an amount of build material deposited in each layer. The apparatus can also include a translating nozzle for delivering the build material to the trough as well as a sensor for measuring the distribution of build material in the trough.

In various embodiments, the printhead is mounted in a carrier, the carrier being mounted in a carriage. The carrier can engage mechanical, electrical, and fluid interfaces of the printhead. In another embodiment, the carrier engages mechanical, electrical, and fluid interfaces of the carriage. The apparatus can also include a printhead stable capable of housing at least one spare printhead, the stable including a subsystem for interchanging printheads for use with the apparatus. Printhead reconditioning means, such as a printhead reconditioning station for performing printhead maintenance can also be included in the apparatus. In one embodiment, a carrier transfer subsystem for transferring the printhead between the carriage, the stable, and the reconditioning station is included.

In another aspect, the invention relates to a method of fabricating a three-dimensional object. The method includes the steps of depositing successive layers of a build material on a stationary build table and depositing a liquid in a predetermined pattern on each successive layer of the build material to form the three-dimensional object.

The method can further include the step of circumscribing the three-dimensional object with additional liquid to form a wall about the three-dimensional object. The wall and the table define a build volume. In one embodiment, the build table is situated within an enclosure. Further, the step of depositing the liquid in a predetermined pattern includes positioning at least one printhead in a three dimensional space above the build table. The step of depositing successive layers of the build material can include dispensing the build material using metering means. In another embodiment, the method includes the step of distributing the deposited build material evenly prior to depositing the liquid.

In a further adaptation, the method can include the step of sensing the amount of liquid deposited onto the build material. The method can also include adjusting the amount of liquid being deposited based on the amount of deposited liquid sensed. In other embodiments, the method includes the step of sensing the amount of build material deposited onto the table, and optionally adjusting the amount of build material being deposited based on the amount of build material sensed. The method can also include the step of filtering the air within the enclosure. Also, the method can include exchanging at least one printhead when the liquid housed in the printhead is sufficiently depleted.

In another aspect, the invention relates to an apparatus for reconditioning a printhead. The apparatus includes a nozzle array for spraying a washing solution towards a face of a printhead and a wicking member disposed in proximity to the printhead face for removing excess washing solution from the printhead face.

In various embodiments, the nozzle array includes one or more individual nozzles. The wicking member and the printhead are capable of relative movement. A fluid source can also be included in the apparatus for providing washing solution to the nozzle array under pressure. In another embodiment, the wicking member includes at least one of a permeable material and an impermeable material.

The nozzle array can be positioned to spray the washing solution at an angle with respect to the printhead face. In another embodiment, the wicking member is disposed in close proximity to the printhead face, without contacting print nozzles located on the printhead face. The spacing between the wicking member and the print nozzles can be automatically maintained. In one embodiment, the spacing is maintained by causing a portion of the wicking member to bear on the printhead face in a location removed from the print nozzles. The apparatus can also include a basin for collecting washing solution and debris.

In another aspect, the invention relates to a method of reconditioning a printhead. The method includes the steps of positioning a face of the printhead relative to at least one nozzle and operating the at least one nozzle to spray washing solution towards the printhead face. Excess washing solution is then removed from the printhead face by passing a wicking member in close proximity to the printhead face, without contacting the printhead face.

In one embodiment, the step of operating the at least one nozzle includes spraying the washing solution at an angle to the printhead face. In another embodiment, the method can include the step of operating the printhead to expel washing solution ingested by the printhead during cleaning. The method can include automatically maintaining a space between the wicking member and print nozzles located on the printhead face by, for example, causing a portion of the wicking member to bear on the printhead face in a location removed from the print nozzles.

These and other objects, along with the advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

The following drawings are not necessarily to scale, emphasis instead being placed generally upon illustrating the principles of the invention. The foregoing and other features and advantages of the present invention, as well as the invention itself, will be more fully understood from the following description of exemplary and preferred embodiments, when read together with the accompanying drawings, in which:

FIG. 1 is a schematic perspective view of a 3D printer in accordance with one embodiment of the invention;

FIG. 2 is a schematic perspective view of a 3D printer enclosed in a housing in accordance with one embodiment of the invention;

FIGS. 3A and 3B are schematic perspective side and front views of the 3D printer of FIG. 2;

FIGS. 4A and 4B are schematic perspective views of the 3D printer of FIG. 1, illustrating the motion of a gantry assembly;

FIG. 5A is an enlarged schematic perspective view of a portion of the gantry assembly of FIGS. 4A and 4B disposed beneath a powder dispenser assembly in accordance with one embodiment of the invention;

FIG. 5B is a schematic perspective view of the gantry assembly of FIG. 5A, including a spreader in accordance with one embodiment of the invention;

FIG. 5C is a schematic side view in partial cross-section of the gantry assembly of FIG. 5A illustrating the flow of a build material;

FIG. 6A is a schematic perspective view of portions of the 3D printer of FIG. 1, showing a build in progress;

FIGS. 6B-6C are schematic side views in partial cross-section of the build in progress;

FIG. 6D is a schematic perspective view of the 3D printer of FIG. 1 while the build is in progress, showing a cross-section of a printed part;

FIG. 7 is a schematic perspective view of the 3D printer of FIG. 1, showing the printed part being removed;

FIG. 8A is a schematic side view of a printhead carrier and a printhead in accordance with one embodiment of the invention;

FIG. 8B is a schematic side view of the printhead and printhead carrier of FIG. 8A coupled together;

FIG. 9 is a schematic perspective view of the printhead carrier of FIG. 8A installed in a printhead carriage in accordance with one embodiment of the invention;

FIG. 10 is a schematic perspective view of the printhead carriage of FIG. 9 and a printhead reconditioning station disposed on the gantry assembly;

FIG. 11 is an enlarged perspective view of the reconditioning station of FIG. 10;

FIGS. 12A-12C are schematic side views of the printhead of FIG. 8A being cleaned at the reconditioning station of FIG. 11;

FIGS. 13A-13D are schematic perspective views of a reconditioning station in accordance with one embodiment of the invention;

FIG. 14 is a schematic perspective view of a printhead carrier storage facility in accordance with one embodiment of the invention; and

FIGS. 15A and 15B are schematic side views of a printhead diagnostics station in accordance with one embodiment of the invention.

### DETAILED DESCRIPTION

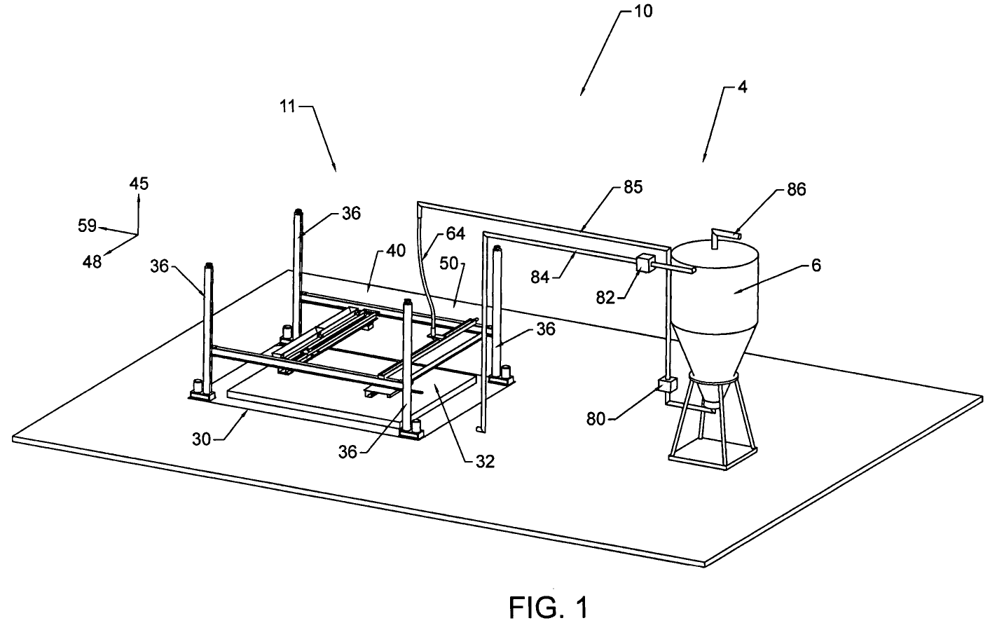

FIG. 1 depicts a 3D printing system 10 in accordance with the invention for fabricating an object from a representation of the object stored in memory. The system 10 can be used to create appearance prototypes for design review and can also be used to create molds for casting applications. Additional uses include mock-ups for form and fit testing and prototypes to collect market feedback. The printing system 10 of the present invention has the ability to create objects that are significantly larger, for example orders of magnitude larger, than those capable of being manufactured by traditional 3-D printing technologies.

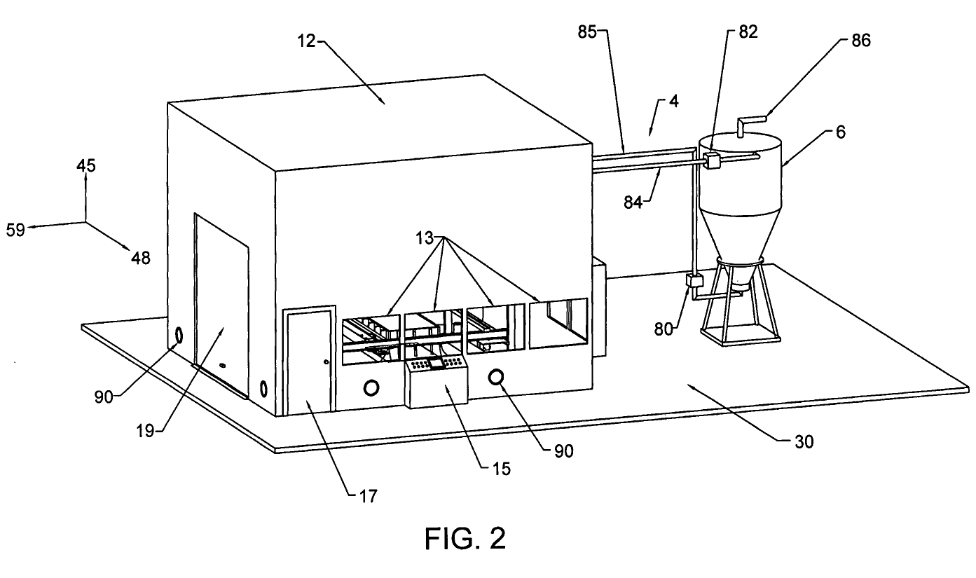

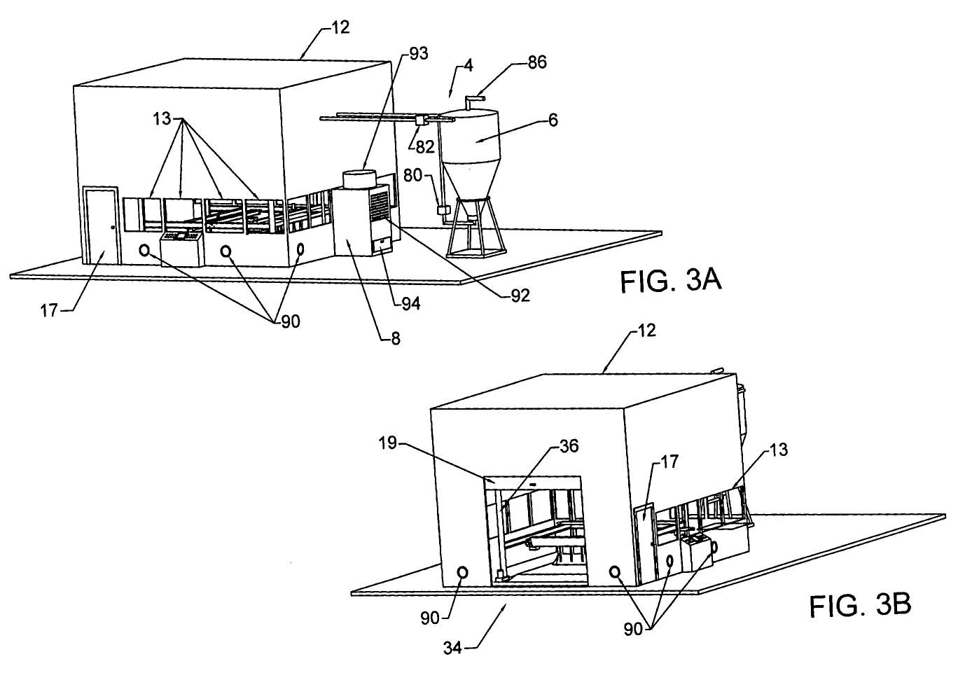

The system 10 includes a 3D printer 11. The printer 11 includes a stationary build table 32, a gantry assembly 40, and a powder dispenser assembly 50. The gantry assembly 40 and the powder dispenser assembly 50 are actuatable along a vertical z-axis 45 to manufacture the part layer by layer. Also included in the system 10 is a powder delivery system 4 to deliver build material 51 to the printer 11 and an air handling apparatus 8 (FIG. 3A) to clean the work environment. Optionally, an enclosure 12 can surround the printer 11 (FIGS. 2-3B).

With reference to FIG. 2, the enclosure 12 can include windows 13 or a video system to enable an operator to view a build in progress. An operator's console 15 houses external control systems that monitor and control the operation of the system 10. The console 15 can be located on an exterior wall of the enclosure 12. The enclosure 12 can also include an operator door 17 and a part removal door 19 to allow access to the interior of the enclosure 12.

FIG. 3A depicts the air handling apparatus 8, which includes air inlets 90 and an exhaust system in fluidic communication with an interior area of the enclosure 12 for drawing air out of the enclosure 12. In the embodiment shown, the air inlets 90 are arranged around the base of the enclosure 12; however, they can be located anywhere on the enclosure. The exhaust system includes a blower 93 for drawing the air out of the enclosure 12 and an exhaust vent 92. One or more filters can also be included in the air handling apparatus 8 to purify the air drawn from the enclosure 12 before it is released into the atmosphere. In one embodiment, the apparatus 8 includes a dust receptacle 94 that captures airborne particulate build material 51 filtered out of the enclosure air.

FIG. 3B depicts the side of the enclosure 12 including the part removal door 19. In the embodiment shown, the door 19 is an overhead type door and the opening is sized such that a fork lift or other material handling equipment can be driven into the enclosure 12 to remove the completed parts. The door 19 can, however, be essentially any size. The size of the opening and door 19 will be determined, at least in part, by the size and nature of the parts being printed.

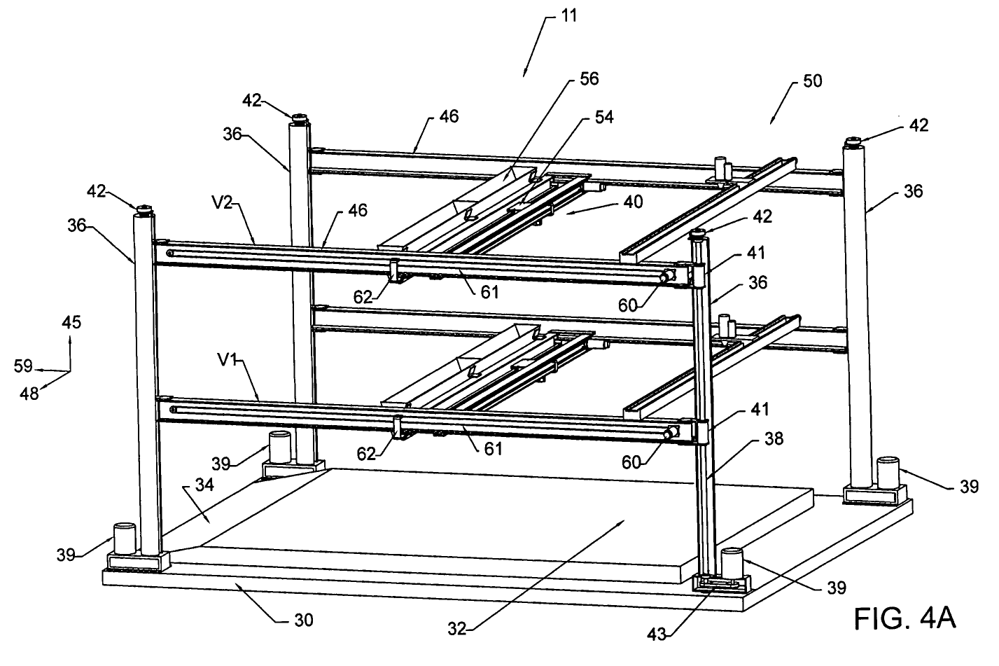

FIGS. 4A and 4B depict the printer 11 in greater detail. The stationary build table 32 of the printer 11 can be made of any material that has sufficient rigidity to avoid deflection, such as concrete or steel, and can be as thick as desired. In one embodiment, a top surface of the build table 32 is about 6 to 8 inches above the floor to allow for clearance around the build table 32. The build table 32 may be laid on a shop floor or, for example, a floor pad 30 of poured concrete that has a level surface on which the build table 32 will rest. Additionally or alternatively, the build table 32 may be located in a room that is designed to be portable, so that the system 10 can be transported to different work locations, as required. Features can be added to the build table 32 to aid the manufacturing of large objects. For instance, a ramp 34 can be included at the periphery of the build table 32 to enable a fork lift to access the printer 11 to remove a completed part 67. Alternatively, one or more robot arms may be located adjacent to the build table 32 to grasp and remove the completed part 67.

At the periphery of the build table 32, and mounted to the pad 30, is a plurality of jack posts 36 that are secured to the pad 30 by fasteners or other methods. In the embodiment shown, four jack posts 36 are mounted to the pad 30, although fewer than four jack posts 36 or more than four jack posts 36 can be used in accordance with the invention. Further, the jack posts 36 can also be mounted on the build table 32 itself, or at different positions on the pad 30 than those illustrated.

With reference to FIG. 4A, a typical jack post 36 is illustrated in partial cross-section. Each jack post 36 includes a lead screw 38 powered by a motor 39, such as a servo motor. The lead screw 38 can be directly coupled to the motor 39 or via a drive belt 43, gear train, etc., which in turn drives the lead screw 38. In one embodiment, side rails 46 are coupled to and supported on the jack posts 36 by a lead screw nut 41 or similar structure disposed on each lead screw 38. Each nut 41 can travel along its corresponding lead screw 38, as the lead screw 38 is rotated. To raise and lower the side rails 46 along the z-axis 45, for instance, between the two vertical positions (V₁, V₂) shown in FIG. 4A, each lead screw 38 is simultaneously actuated. The lead screws 38 can be mechanically or electronically coupled together to assure that each lead screw 38 is rotated the same amount, so that the side rails 46 remain substantially parallel to the build table 32 throughout the printing process. The size of the lead screw 38 can vary to suit a particular application. For example, the number of and the length (i.e., height) of the lead screw 38 will be determined based on the overall build volume required. In addition, the thread pitch of the lead screws 38 will be selected, in part, to determine the indexing rate of the side rails 46. In one example, the lead screw has a threaded length of 96 inches, a diameter of 1.5 inches, and a pitch of 10 threads per inch.

To provide feedback on the position of the side rails 46, an encoder 42 is mounted to the top of each lead screw 38 and tracks the angular position of each lead screw 38 and/or nut 41. Alternatively, optical sensing techniques, such as laser-based systems, may be used to accurately determine the position of each lead screw 38 or the side rails 46. In an alternative embodiment, each jack post 36 can include a hydraulic cylinder to incrementally raise the side rails 46. In another alternative fluidic system, compressed air or gas pumps can be used to control the vertical position of the side rails 46.

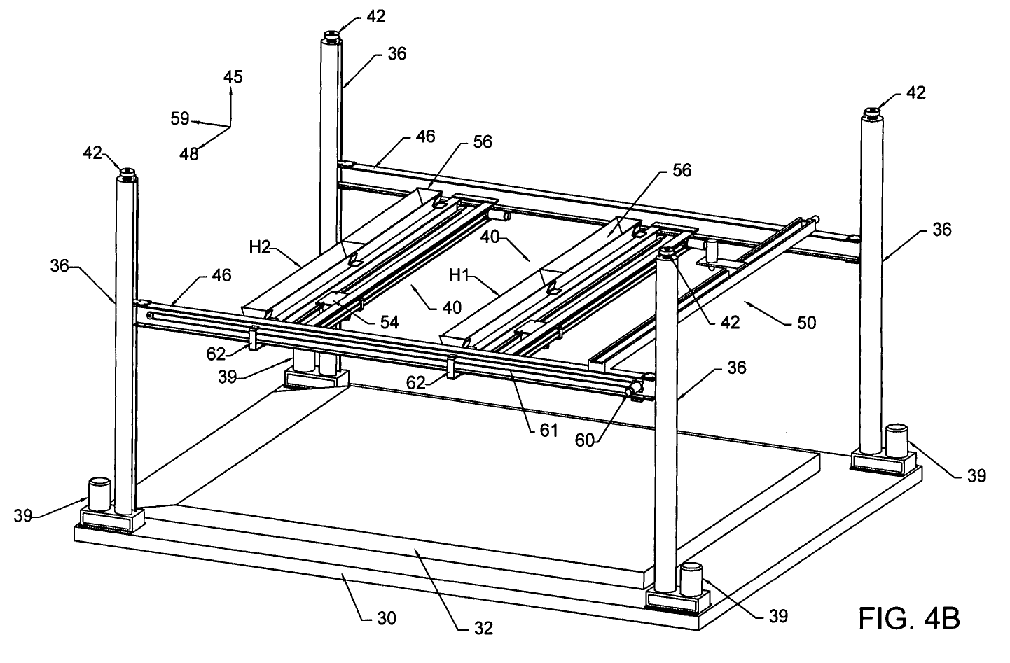

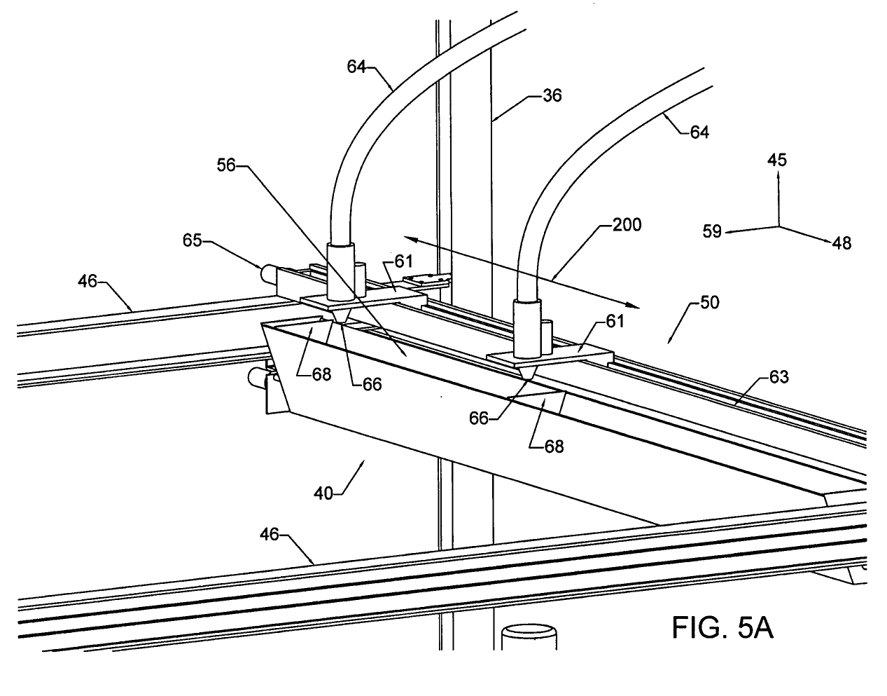

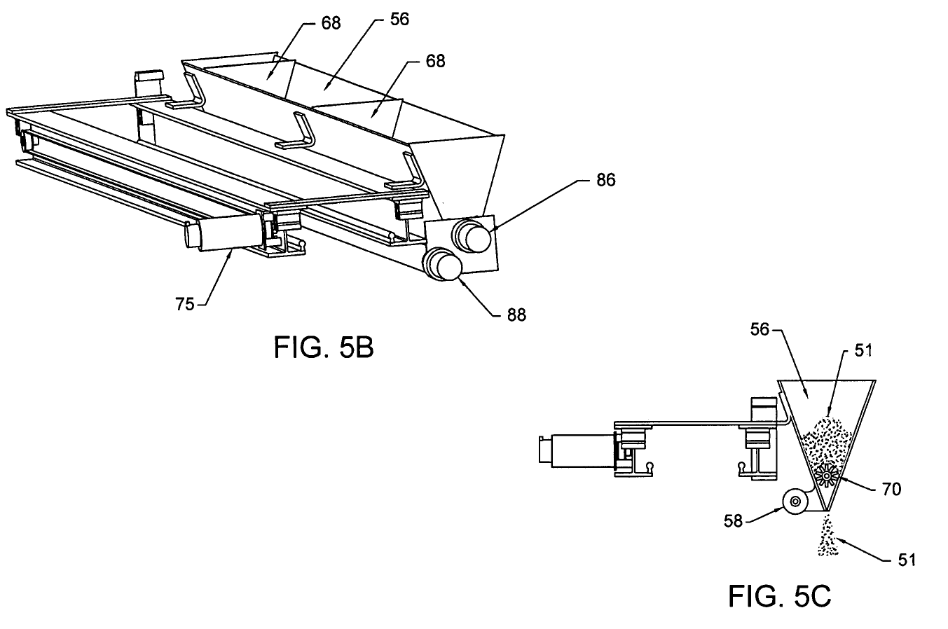

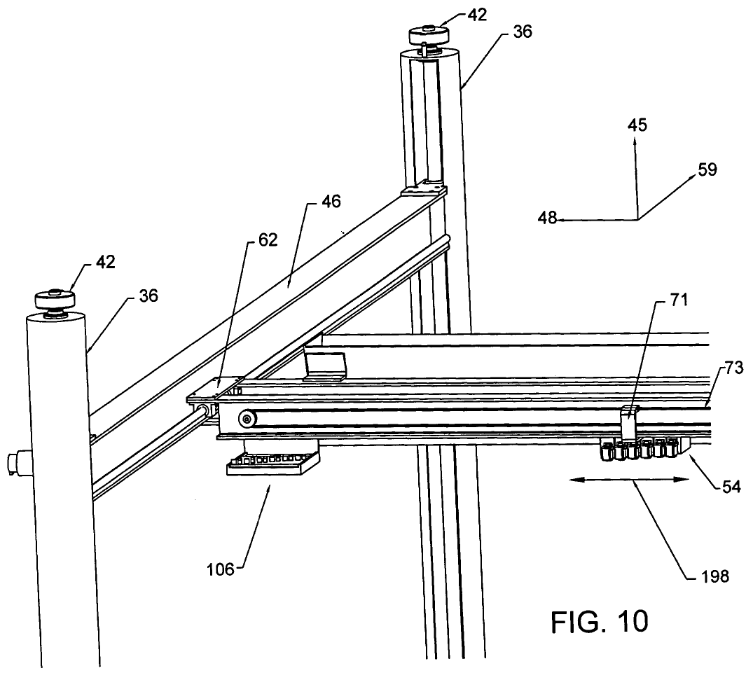

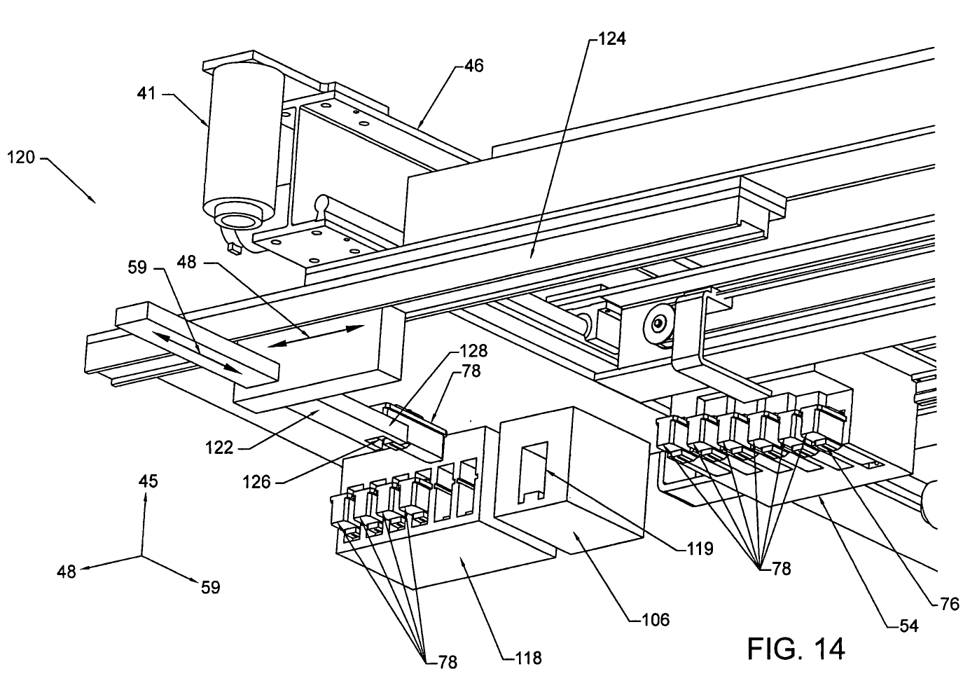

The side rails 46 support the gantry assembly 40. Included in the gantry assembly 40, in one embodiment, are a printhead carriage 54, a printhead reconditioning station 106 (FIG. 10), a printhead stable 118 (FIG. 14), a powder receiving trough 56, and a spreader assembly 58 (FIG. 5C). As illustrated in FIG. 4B, the gantry assembly 40 can be actuated along an x-axis 59 to assume different horizontal locations (H₁, H₂) above the build table 32. In one embodiment, to move the gantry assembly 40 along the x-axis 59, a motor 60 actuates a drive belt 61 that is coupled to the gantry assembly 40 by a bracket 62. In an alternative embodiment, the gantry assembly 40 may be coupled to a lead screw, such that rotation of the lead screw moves the gantry assembly 40 along the x-axis 59. Other positioning systems may be employed, as desired.

Also mounted on and supported by the side rails 46 is the powder dispenser assembly 50. The powder dispenser assembly 50 in the illustrated embodiment is fixed in position at a distal end of the printer 11. In an alternative embodiment, the powder dispenser assembly 50 can also travel along the side rails 46 through the use of a motor and drive belt or other system, as described above with reference to the gantry assembly 40.

In operation, the powder receiving trough 56 is loaded with the build material 51, which is then distributed onto the build table 32. As shown in FIG. 5A, to load the powder receiving trough 56 with the build material 51, the gantry assembly 40 is actuated along the x-axis 59 until the trough 56 of the gantry assembly 40 is beneath the powder dispenser assembly 50. Included in the powder dispenser assembly 50 is a powder dispenser 61 that can travel along a y-axis 48 between the side rails 46 to deposit the build material 51 into the trough 56. The powder dispenser 61 moves along the y-axis 48 on a lead screw 63 or other system that is actuatable by a motor 65.

Coupled to the powder dispenser 61 is the powder delivery system 4 (FIGS. 1, 2, and 3A). Included in the powder delivery system 4 are a powder supply duct 85 and a powder supply line 64. The duct 85 is typically rigid, while the supply line 64 is made from a flexible material that can bend as the powder dispenser 61 traverses the y-axis 48 to deliver build material 51 to the trough 56. In one embodiment, the powder supply line 64 is a reinforced hose. Further included in the powder delivery system 4 is a powder supply hopper 6 that holds the build material 51 during operation of the printer 11. The powder supply hopper 6 includes a fill duct 86 to enable the hopper 6 to be re-supplied with build material 51, as required. A pump 80 coupled to the powder supply hopper 6 pumps the build material 51 in a controlled manner from the powder supply hopper 6 to the trough 56 through the powder supply duct 85 and the powder supply line 64 during the operation of the printer 11. Once the build material 51 reaches the powder dispenser 61, the build material 51 travels through a nozzle 66 that directs the build material 51 into the trough 56. A second pump 82 connected to a return duct 84 may be operated to pump unused build material 51 from the printer 11 back to the powder supply hopper 6. Additional details of various types of such powder delivery systems can be found in U.S. Provisional Patent Application No. 60/472,922, the disclosure of which is hereby incorporated by reference herein in its entirety.

Referring back to FIG. 5A, in some embodiments, the trough 56 includes one or more dividers 68 that can be adjusted to any desired position along the width of the trough 56 so that only the portion of the trough 56 that is above a particular build surface is filled with build material 51, thereby setting the build surface width. Similarly, the motion of the powder dispenser 61 along the y-axis 48 (indicated by arrow 200) can be computer controlled, so that only the portion of the trough 56 between the dividers 68, or one divider 68 and a side wall of the trough 56 is filled with the build material 51. This reduces the amount of the build material 51 supplied to the build table 32 in situations when the entire width of the build table 32 is not being utilized to produce the part 67. Printing speed is also enhanced, since the time required to fill the trough 56 is reduced.

With reference to FIGS. 5B-5C, also included in the trough 56 is an agitator 70 to mix the build material 51 in the trough 56 to maintain the build material 51 in a loose powder form. The agitator 70 may be an auger or a sifter that is actuated by a motor 86. In another embodiment, a plurality of augers 70 is used in the trough 56 to mix the build material 51. The trough 56 can also include sensors to track the amount of build material 51 held in the trough 56.

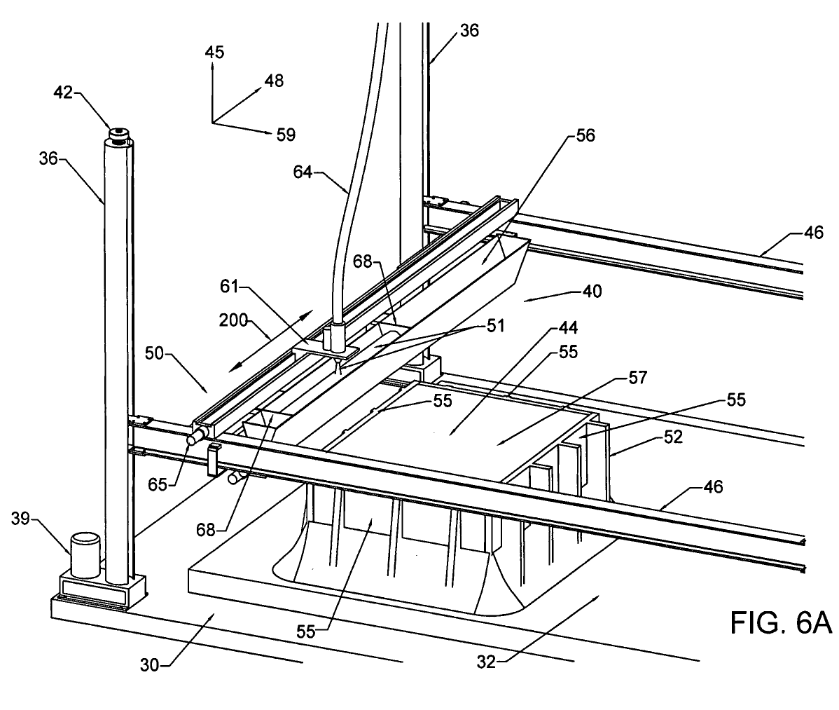

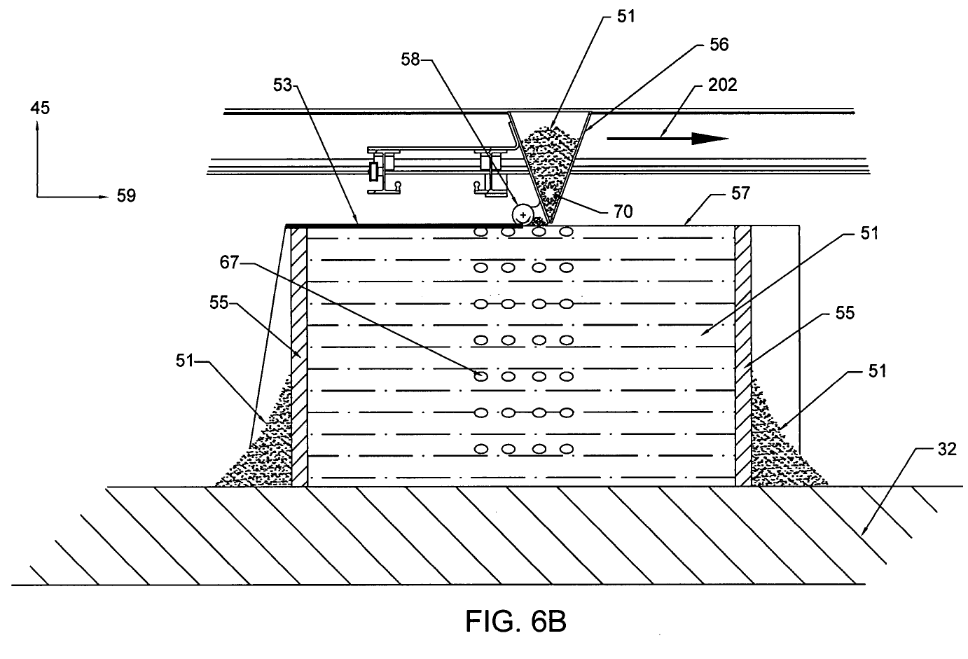

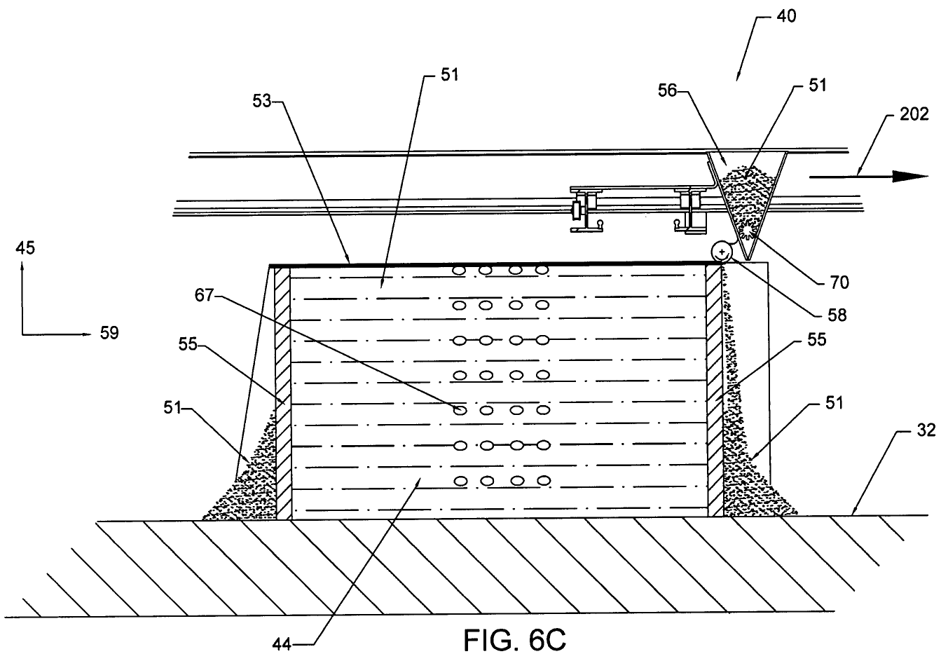

Once the build material 51 is released onto the build table 32, the spreader assembly 58 coupled to the gantry assembly 40 distributes the build material 51 over at least a portion of the build table 32 and smoothes the build material 51 to create a top layer 53 (FIG. 6C) of build material 51 with a substantially even thickness. Typically, the thickness of the top layer 53 of build material 51 ranges from about 3/1000 of an inch to about 10/1000 of an inch; however, the thickness can vary to suit a particular application. In the illustrated embodiment, the spreader assembly 58 includes a roller that is actuated by a motor 88 to turn counter-clockwise, as shown in FIG. 6C. In other embodiments, the spreader assembly 58 can include a knife or any other suitable apparatus. As shown in FIGS. 6B-6C, by turning counter-clockwise, the spreader 58 causes any excess build material 51 deposited onto the build table 32 to accumulate between the trough 56 and the spreader 58. As the gantry assembly 40 moves along the x-axis 59, the excess build material 51 is spilled over side walls 55 surrounding the build surface 57 or eventually falls over the side walls 55 once the top layer 53 of build material 51 is fully applied (FIG. 6C). The excess build material 51 acts to reinforce the printed side walls 55. In one embodiment, the spreader assembly 58 includes a roller scraper that removes build material 51 that may become stuck to the spreader roller.

FIGS. 6A-6D depict the building of a part 67 that is smaller than the width of the build table 32. With reference to FIG. 6A, the trough 56 is shown beneath the powder dispenser assembly 50 as it is being filled with the build material 51. The dividers 68 in the trough 56 are being used so that only the portion of the trough 56 that is situated above the build surface 57 is filled with the build material 51. The powder supply line 64 is filling the trough 56 with build material 51, as it and the powder dispenser 61 travel along the y-axis 48. Computer control can be used to adjust the rate of flow of the build material 51 into the trough 56. Likewise, computer control can be used to control the rate at which the powder dispenser 61 travels along the y-axis 48.

Once the trough 56 is filled with build material 51, the gantry assembly 40 moves away from the powder dispenser assembly 50 along the x-axis 59, as indicated in FIG. 6B by arrow 202. As the gantry assembly 40 travels along the x-axis 59, the trough 56 deposits a fresh layer of build material 51 onto the build surface 57. The rate at which the auger 70 rotates, and hence the rate at which build material 51 is deposited onto the build surface 57 can be regulated by, for example, computer control. A sensor can be included to determine the flow rate of build material 51 onto the build table 32. The build material 51 is then spread across the surface 57, as previously described. Also, a sensor can be used to determine that an appropriate amount of build material 51 has been spread across the build surface 57.

Once the top layer 53 of build material 51 has been deposited on the build surface 57, the gantry assembly 40 begins travelling back along the x-axis 59 towards the powder dispenser assembly 50, as represented by arrow 204 (FIG. 6D). As the gantry assembly 40 travels along the x-axis 59, the printhead carriage 54, which is mounted on a bracket 71 connected to a drive belt 73 driven by a motor 75, moves back and forth along the y-axis 48 as represented by arrows 206. As the printhead carriage 54 moves over the build surface 57, binding material is deposited on at least a portion of the build surface 57 in a two-dimensional pattern. The binding material can be delivered to the top layer 53 of build material 51 in any predetermined two-dimensional pattern, using any convenient mechanism, such as an inkjet printhead driven by software in accordance with article model data from a computer-assisted-design (CAD) system.

In addition to forming the part 67, with each fresh layer of build material 51 deposited on the build surface 57, binding material is printed to form the walls 55 around the build surface 57. The walls 55 define the build volume 44. The printed walls 55 help support the part 67 and the build material 51 between the walls 55. As mentioned, the build material 51 that spills over the walls 55 also helps support the build volume 44 by acting like a truss. In addition, buttresses 52 can be printed in connection with the printed walls 55.

The printer 11 can include one or more sensors to monitor the amount of build material 51 deposited on the build surface 57. Additionally, a sensor could be used to measure the thickness and/or uniformity of the layer of deposited build material 51. In one example, an optical sensor is used to monitor the amount of build material that spills over at least a portion of the walls 55. In another example, an optical sensor can be used to differentiate between a fresh layer of build material 51 and a printed layer. Such an arrangement could indicate whether enough build material was spread across the build surface 57. For example, if an optical sensor was disposed proximate one or more of the buttresses 52 and too little build material 51 is spread across the build surface 57, the optical sensor will detect a printed layer, not a fresh layer, thereby indicating too little build material 51 was deposited.

When applied to the build material 51, the binding material, generally in liquid form, causes the build material 51 contacted by the fluid to adhere together to form an essentially solid layer that becomes a cross-sectional portion of the finished part 67. Reference is made to U.S. Provisional Application Ser. No. 60/472,221, the disclosure of which is hereby incorporated herein by reference in its entirety, which describes materials that can be used as the build material 51 and the binding material. As one example of how the build material 51 and the binding material interact to form the finished part 67, when the binding material initially comes into contact with the build material 51, it immediately flows outwardly (on a microscopic scale) from the point of impact by capillary action, dissolving the build material 51 within a relatively short time period, such as the first few seconds. As the binding material dissolves the build material 51, the fluid viscosity increases dramatically, arresting further migration of the binding material from the initial point of impact. The binding material and the build material 51 to which it has adhered form a rigid structure, which becomes a cross-sectional portion of the finished part 67.

Any build material 51 that was not exposed to the binding material (the “unbound build material”) remains loose within the build volume 44. The unbound build material 69 is typically left in place until formation of the final part 67 is complete. Leaving the unbound build material 69 in place ensures that the part 67 is fully supported during printing, allowing features such as overhangs, undercuts, and cavities to be defined and formed without the need to use supplemental support structures. After formation of the first cross-sectional portion of the part 67, the gantry assembly 40 is indexed upwardly.

The gantry assembly 40 may again be positioned beneath the powder dispenser assembly 50, where it is re-supplied with build material 51. Another layer of the build material 51 is then applied over the previous layer, covering both the rigid first cross-sectional portion, and any unbound build material 69. A second application of the binding material follows in the manner described above, causing the build material 51 to selectively adhere together to form a second essentially solid cross-sectional portion of the finished part 67. The gantry assembly 40 is again indexed upwardly along the z-axis 45, and the process continues until the part 67 is completed.

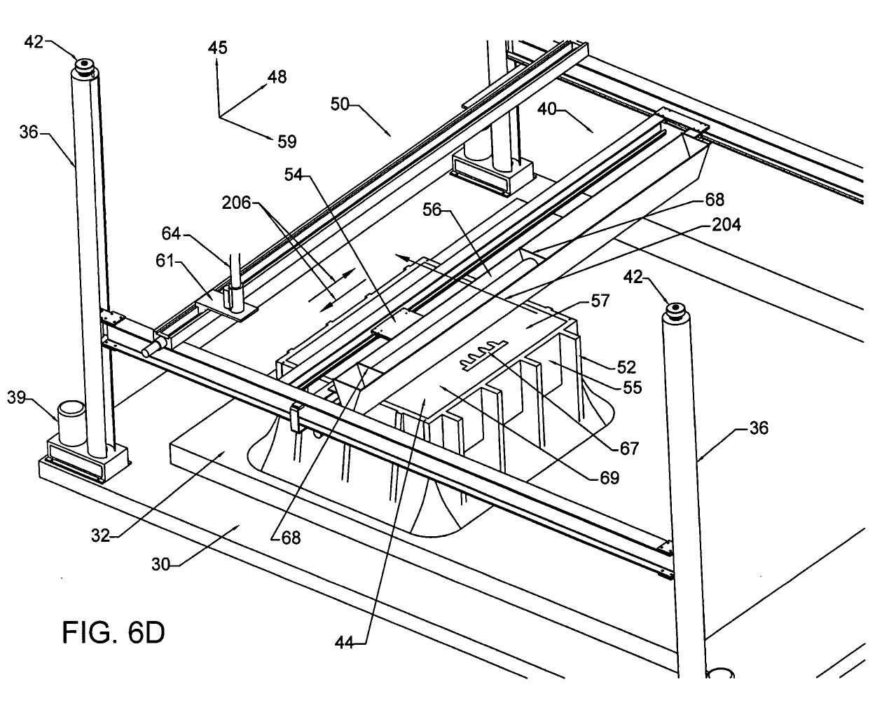

With reference to FIG. 7, upon completion of the part 67, the side rails 46 are raised to their topmost position along the z-axis 45 and the gantry 40 is moved along the x-axis 59 to the end of the build table 32 opposite the ramp 34. The excess build material 51 surrounding the side walls 55 is then removed, for instance, by a vacuum or a pressurized air supply. Next, at least one wall 55 surrounding the part 67 is removed, for instance by a robotic arm operated from outside the enclosure 12, and the unbound build material 69 between the walls 55 is removed by pressurized air flow or a vacuum. Alternatively, the wall 55 and excess build material 51 may be removed manually; however, the air handling apparatus should be operated prior to opening or entering the enclosure 12, as the inside air may contain a high concentration of particles of build material 51.

After removal of the unbound build material 69, the air handling apparatus 8 is used to filter the air inside the enclosure 12. Prior to the air from the enclosure 12 being exhausted into the outside environment, the filter can be used to purify the air. After the air inside the enclosure 12 has been purified, the finished part 67 can be removed from the build table 32 through the use of a fork lift or any other suitable means, such as a robotic arm. It is desirable to run the air handling apparatus 8 prior to opening any of the doors 17, 19, because, as previously discussed, a significant amount of dust may be present in the environment inside the enclosure 12. Running the air handling apparatus 8 purifies the air and prevents disbursement of the dust into the environment external to the enclosure 12.

After removal, a post-processing treatment may be performed on the part 67, such as cleaning, infiltration with stabilizing materials, painting, etc. A suitable infiltrant for stabilizing the materials may be selected from, for example, epoxy-amine systems, free radical UV cure acrylate systems, cationic UV cure epoxy systems, two-part urethane systems including isocyanate-polyol and isocyanate-amine, cyanoacrylate, and combinations thereof. Post-processing may also include heating the part 67 to sinter at least partially the build material 51. Sintering may be done, for example, at 110° C. for about 45 minutes, depending on the constituents of the part 67. In addition, the part 67 produced by the system 10 can be drilled, tapped, sanded and painted, or electroplated, as required.

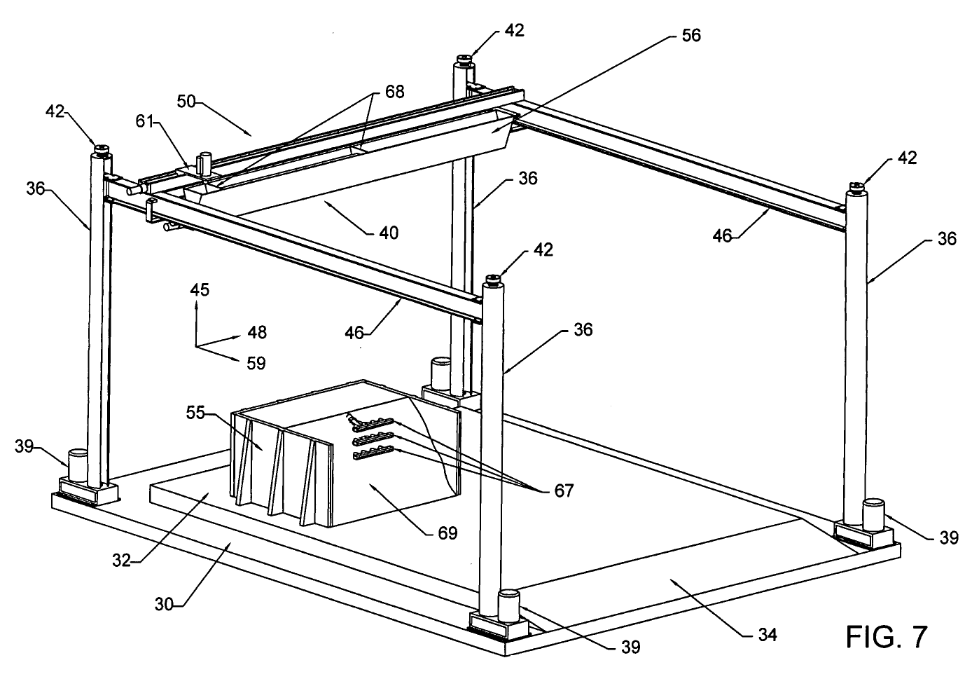

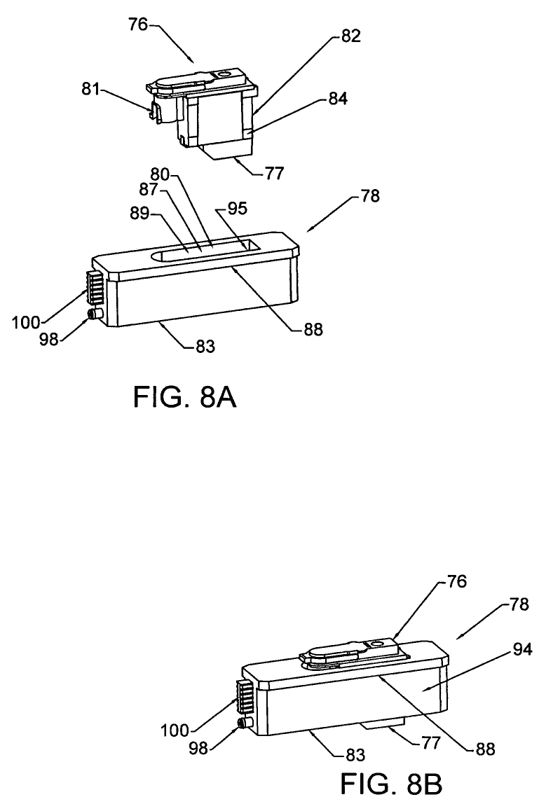

3D printers benefit greatly from the use of standard, commercially available printheads. The development cost of these printheads has been absorbed by their intended high-volume applications, and their cost is low. A difficulty arises, however, because the usable life of a commercial printhead may not be adequate to print the very large parts contemplated by this invention. A successful application may therefore require that the printheads be routinely replaced one or more times in the course of printing a single part. It is desirable that printhead replacement be automatically performed by the 3D printer whenever a printhead has reached the end of its life. FIGS. 8A-8B depict a means of providing an adapter between a printhead and the 3D printer to facilitate automatic handling. FIG. 8A shows a printhead 76 and a printhead carrier 78. The printhead carrier 78 includes a socket 87 that is adapted to receive the printhead 76. The socket 87 includes physical alignment features 89 that interface with alignment features 84 on the printhead 76 to position the printhead 76 precisely with respect to the carrier 78. The socket 87 also includes an electrical connector 95 that interfaces with an electrical connector 82 on the printhead 76. When the printhead 76 is inserted into the printhead carrier 78, a printhead face 77 of the printhead 76 protrudes beneath a bottom surface 83 of the printhead carrier 78. Referring to FIG. 8B, the printhead carrier 78 has external features that interface with the 3D printer. Gripping surfaces 94 allow the carrier 78 to be grasped and transported. Alignment features 88 allow the carrier 78 to be accurately positioned with respect to the 3D printer 10. A fluid connector 98 and an electrical connector 100 interface with corresponding features in the 3D printer 10.

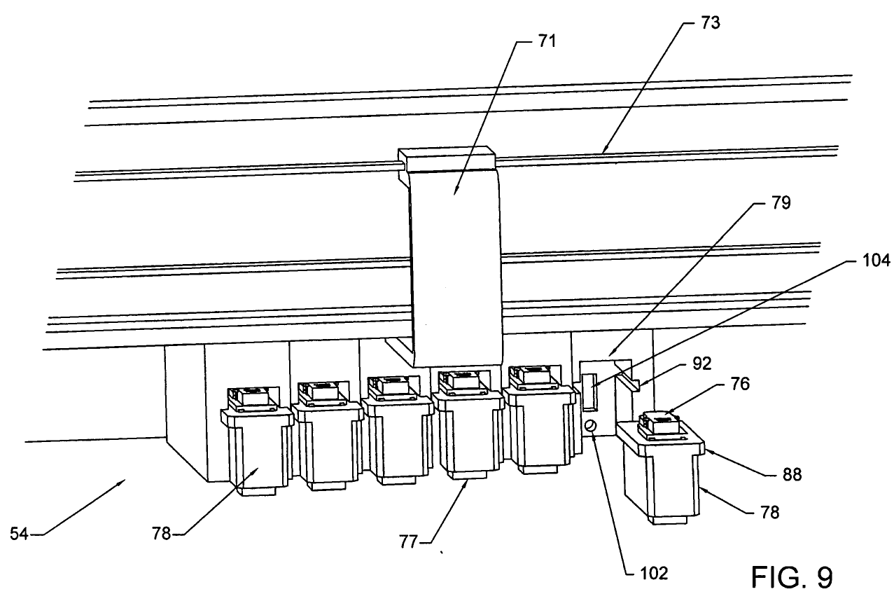

The printhead carriage 54, as depicted in FIG. 9, is adapted to hold a plurality of printhead carriers 78. A plurality of printhead carriers 78 is advantageous when manufacturing large objects, since the manufacturing of large objects requires large volumes of binding material. Having a plurality of printhead carriers 78 increases the potential total binding material flow rate, and thus allows a part to be built more rapidly. In addition, having a plurality of printhead carriers 78 eliminates downtime that may occur should a printhead 76 malfunction. In embodiments including a plurality of printhead carriers 78, printing can continue with an alternate printhead 76 without stopping the system 10, should a printhead 76 malfunction during operation.

With reference to FIGS. 8A, 8B, and 9, the printhead carrier 78 includes alignment features 88 that mate with corresponding surfaces 92 in the printhead carriage 54 to guide the insertion of the printhead carrier 78 into the socket 79 of the printhead carriage 54. Removal and insertion of the printhead carrier 78 from the printhead carriage 54 is also enhanced by the gripping surfaces 94 on the exterior surface of the printhead carrier 78 that allow the printhead carrier 78 to be grasped by a printhead transfer mechanism 96 (later described). When inserted into the printhead carriage 54, the fluid carrier connection 98 and the electrical contacts 100 of the printhead carrier 78 are received in corresponding sockets 102, 104 in the printhead carriage 54.

The printhead carriers 78 can be inserted into the printhead carriage 54 such that the printheads 76 are offset from each other along the x-axis 59. As illustrated in FIG. 10, the printhead carriers 78 are offset from each other by approximately the same distance along the x-axis 59. In other embodiments, however, the printhead carriers 78 can be staggered within the printhead carriage 54 such that the distances between printheads 76 vary. Disposing the printhead carriers 78 in the printhead carriage 54 in an offset or staggered pattern enables a larger volume of the part 67 to be printed with each pass of the printhead carriage 54 along the y-axis 48.

In another embodiment, to improve the printing performance of the system 10 and eliminate downtime, the system 10 can include sensors to indicate if a printhead 76 is malfunctioning, for instance, because it is out of binding material. In this situation, the alignment of the printhead carriers 78 within the printhead carriage 54 can be adjusted during printing so that printing may continue without stopping the system 10 for maintenance. For instance, the printhead carrier 78 locations within the printhead carriage 54 can be altered so that no gaps in the printing of binding material occur in each pass of the printhead carriage 54 along the y-axis 48.

With continued reference to FIG. 10, to further improve the performance of the system 10, a printhead reconditioning station 106 can be included on the gantry assembly 40. The printhead reconditioning station 106 in the illustrated embodiment is stationary and located near one of the side rails 46; however, in other embodiments, the reconditioning station 106 can be mobile. As illustrated in FIG. 10 by arrow 198, the printhead carriage 54 can be actuated to move into the reconditioning station 106.

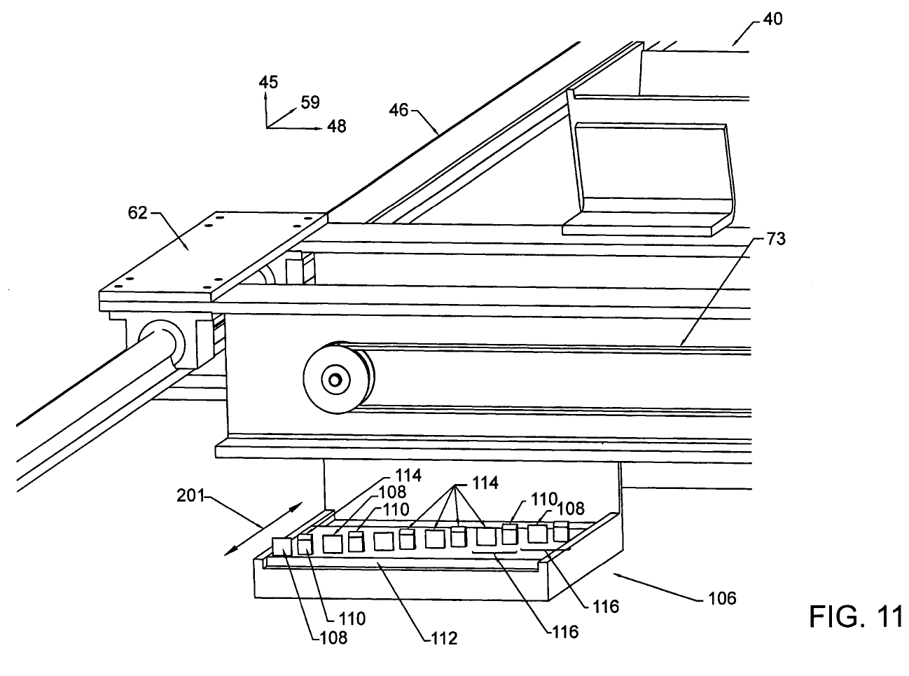

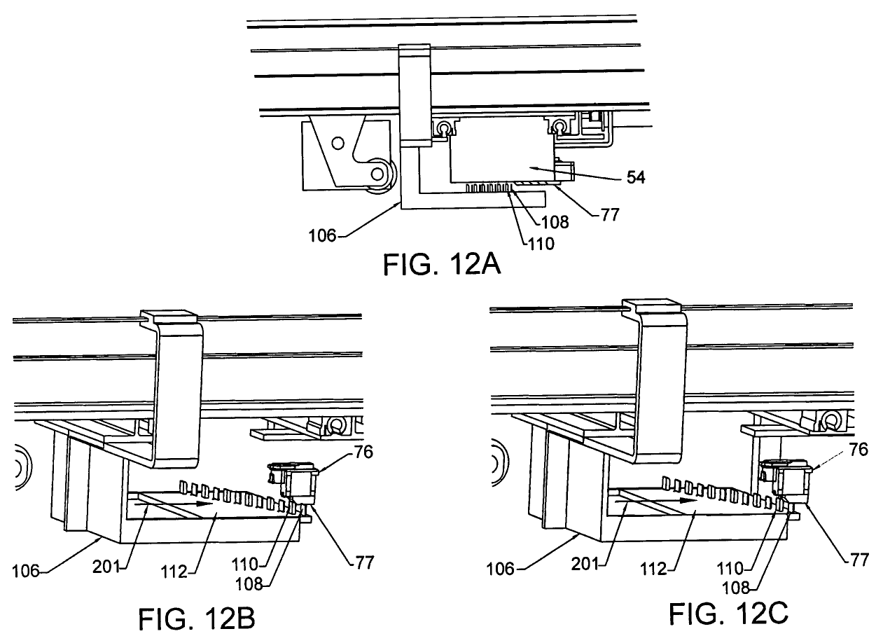

FIG. 11 depicts one embodiment of the reconditioning station 106 in greater detail. The reconditioning station 106 includes a plurality of wiping elements 108 and a plurality of lubricators 110. The wiping elements 108 and the lubricators 110 are mounted on a plate 112 that can be actuated to travel along the x-axis 59 as indicated by arrow 201. The engaging surfaces 114 of the wiping elements 108 and the lubricators 110 are disposed upwards so that when the printhead carriage 54 is in the reconditioning station 106, the wiping elements 108 and the lubricators 110 clean the printheads 76 from below (FIGS. 12A-12C). Also, in the illustrated embodiment, one wiper 108 and one lubricator 110 acting as a pair 116 are used to clean each printhead 76 included in the carriage 54. Further, in the illustrated embodiment, each wiper and lubricator pair 116 are offset from each other to correspond with the offset spacing of the printheads 76 (FIG. 10). In other embodiments, however, any number of wiping elements 108 and lubricators 110 can be used to clean the printheads 76, and the wiping elements 108 and lubricators 110 can be spaced using any desirable geometry.

FIGS. 12A-12C depict one method of using the reconditioning station 106. The printhead carriage 54 is moved along the y-axis 48 so that the printhead carriage 54 is disposed above the reconditioning station 106 (FIG. 12A). The plate 112 on which the wiping elements 108 and lubricators 110 are mounted is then actuated into alignment with the printheads 76, and the printheads 76 are wiped and lubricated from beneath to remove any accumulated grit and to improve the flow of binding material out of the printheads 76. Specifically, the lubricator 110 applies a lubricant to the printhead face 77 to moisten any debris on the printhead face 77. Then, the printhead 76 is moved to pass the printhead face 77 over the wiping element 108 (e.g., a squeegee), which wipes the printhead face 77 clean. Alternatively, the printhead face 77 could be exposed to a vacuum source to remove any debris present thereon.

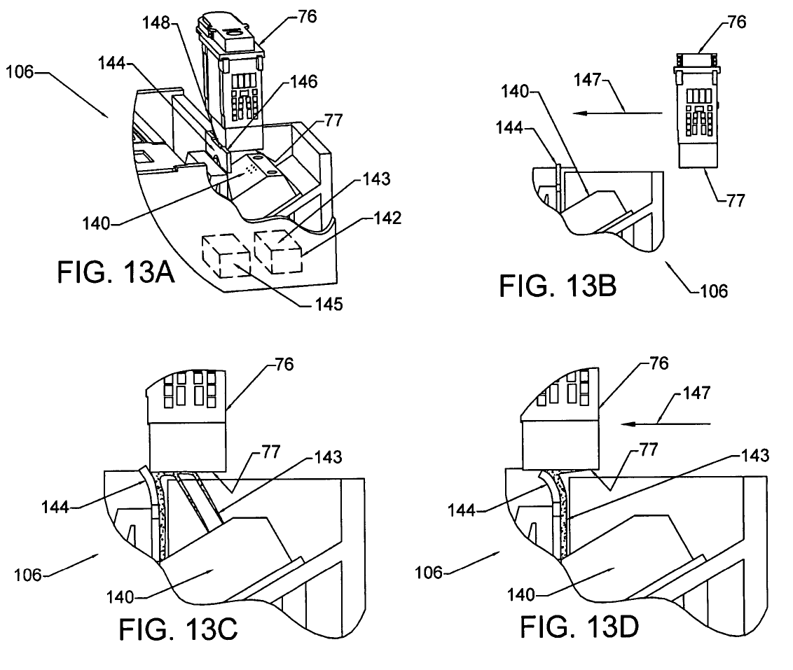

FIGS. 13A-13D depict an alternative embodiment of a reconditioning station 106 in accordance with the invention. The reconditioning station 106 includes a reservoir 142 that holds a washing solution 143 and a pump 145 that delivers the washing solution 143 under pressure to at least one nozzle 140 and preferably an array of nozzles 140. The nozzles 140 are capable of producing a high velocity stream of washing solution 143. In operation, the nozzles 140 are directed to the printhead face 77 of the printhead 76. When directed onto the printhead face 77, the washing solution 143 loosens and removes contaminants, such as build material and binding material, from the printhead face 77. The orientation of the nozzles 140 may be angled with respect to the printhead face 77, such that a fluid flow is induced across a plane of the printhead face 77. For example, the washing solution can contact the printhead 76 at the side nearest the nozzles 140 and drain from the side of the printhead 76 furthest from the nozzles 140. This approach improves the efficacy of the stream of washing solution 143 by reducing the accumulation of washing solution on the printhead face 77, as well as the amount of washing solution 143 and debris that would otherwise drain near and interfere with the nozzles 140. A splash guard may also be included in the reconditioning station 106 to contain splashing resulting from the streams of liquid washing solution 143.

It is desirable to remove a large portion of the washing solution 143 that remains on the printhead face 77 after the operation of the nozzles 140 is complete. This is conventionally accomplished by drawing a wiping element 108 across the printhead face 77, as shown in FIG. 12C. A disadvantage of this approach is that contact between the wiping element 108 and the printhead face 77 may degrade the performance of the printhead 76 by, for example, damaging the edges of the inkjet nozzle orifices. Accordingly, it is an object of this invention to provide a means of removing accumulated washing solution from the printhead face 77, without contacting the delicate region around the inkjet nozzles. In one embodiment, a wicking member 144 may be disposed such that the printhead face 77 may pass one or more times over its upper surface 146 in close proximity, without contact, allowing capillary forces to draw accumulated washing solution 143 away from the printhead face 77. The wicking member 144 may be made from rigid, semi-rigid, or compliant materials, and can be of an absorbent or impermeable nature, or any combination thereof.

For the wicking member 144 to effectively remove accumulated washing solution 143 from the printhead face 77, the gap between the upper surface 146 of the wicking member 144 and the printhead face 77 must be small, a desirable range being between about 0 inches to about 0.03 inches. A further object of this invention is to provide a means for maintaining the gap in this range without resort to precise, rigid, and costly components.

In another embodiment, the wicking member 144 may consist of a compliant rubber sheet oriented approximately orthogonal to the direction of relative motion 147 between the wicking member 144 and the printhead 76 and with a portion of its upper edge 146 disposed so that it lightly contacts or interferes with the printhead face 77 only in non-critical areas away from the printhead nozzle orifices. The upper edge 146 of the wicking member 144 may include one or more notches 148 at locations where the wicking member 144 might otherwise contact delicate components of the printhead face 77. System dimensions are selected so that the wicking member 144 always contacts the printhead face 77, and is deflected as the printhead 76 passes over it, independent of expected variations in the relative positions of the printhead 76 and the reconditioning station 106. The upper edge 146 accordingly follows the position of the printhead face 77, maintaining by extension a substantially constant space between the printhead face 77 and the relieved surface notch 148. To further prolong the life of the printhead 76, a bending zone of the wicking object 144 can be of reduced cross-section to provide reliable bending behavior with little deformation of the upper edge 146 of the wicking member 144.

FIGS. 13B-13D illustrate a reconditioning cycle in accordance with the invention. FIG. 13B shows the printhead 76 approaching the reconditioning station 106 along the path 147. When the printhead 76 lightly contacts the wiping member 144 as shown in FIG. 13C, motion stops along the path 147 and the washing solution 134 is directed at the printhead face 77 by the nozzle array 140. When the spraying operation is complete, the printhead 76 continues to travel along the path 147, as shown in FIG. 13D. The wiping member 144 is further deflected to allow passage of the printhead 76, and the accumulated washing solution 143 is wicked away from the printhead face 77. After being sprayed and wiped, the printhead 76 may print a plurality of droplets to eject any washing solution that may have been ingested during the reconditioning process.

A printhead stable 118 can also be used in accordance with the invention as shown in FIG. 14. The printhead stable 118 can be used to store replacement and used printheads 76 and printhead carriers 78. To transfer printhead carriers 78 between the printhead stable 118 and the printhead carriage 54, a printhead transfer mechanism 120 is included in the system 10. The transfer mechanism 120 includes an arm 122 moveable along the x-axis 59 and a track 124 for moving the arm 122 along the y-axis 48. A gripper 126 is attached to an end 128 of the arm 122 and can be actuated to grasp the printhead carriers 78 on their gripping surfaces 94. To transfer a printhead carrier 78 between the printhead stable 118 and the printhead carriage 54, the printhead carriage 54 is moved into a position proximate the stable 118 that allows for efficient exchange of the printhead carriers 78. The gripper 126 is then used to grasp a printhead carrier 78 from the printhead stable 118. X-axis 59 and y-axis 48 motion controls are then used to position the printhead carrier 78 into the printhead carriage 54 before the gripper 126 releases the printhead carrier 78. Similar steps are taken to remove a printhead carrier 78 from the printhead carriage 54 and to deposit the carrier 78 in the printhead stable 118. Additionally, a reconditioning station 106 can be disposed adjacent to the stable 188. The station 106 shown includes a receptacle 119 for receiving a printhead carrier 78. The reconditioning station 106 may have provisions for purging the printhead 76 of accumulated air and flushing the interior channels of the printhead 76 with a washing solution.

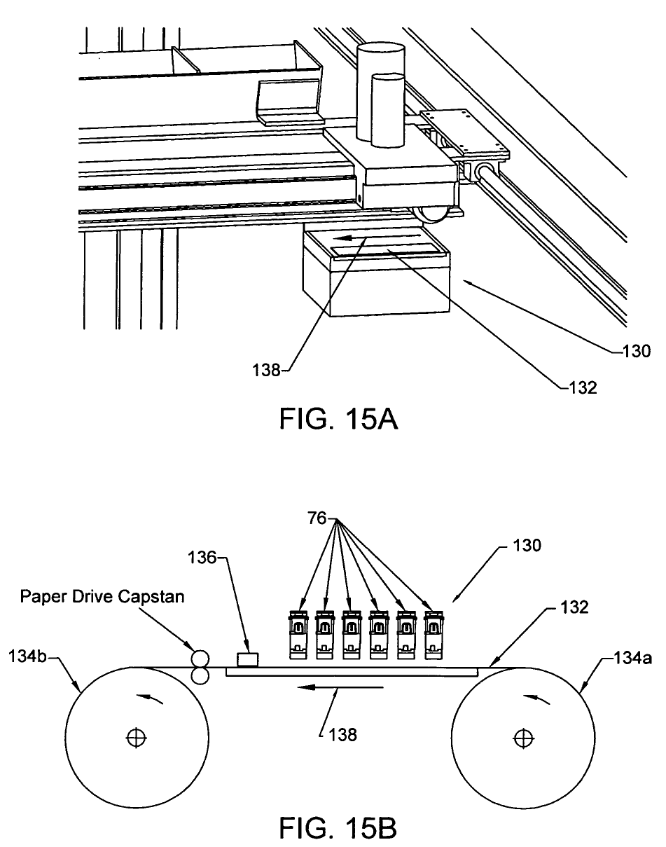

A diagnostic station 130 that can be used to check that the printheads 76 are functioning properly at any stage of the printing process, but particularly after the replacement of printhead carriers 78, is shown in FIGS. 15A and 15B. Included in the diagnostic station 130 is a motor that rolls chart paper 132 between a pair of rollers 134a, 134b in the direction indicated by arrow 138. To utilize the diagnostic station 130, the printhead carriage 54 is moved along the y-axis 48, so that the printhead carriage 54 assumes a position above the chart paper 132. The printheads 76 then print a test sample of binding fluid on the chart paper 132 and a sensor 136 is used to inspect that printing in fact occurred, and that a proper amount of binding material was deposited on the chart paper 132 by each printhead 76. In the event that a problem is encountered, a replacement printhead carrier 78 can be obtained from the printhead stable 118.

Those skilled in the art will readily appreciate that all parameters listed herein are meant to be exemplary and actual parameters depend upon the specific application for which the methods and materials of the present invention are used. It is, therefore, to be understood that the foregoing embodiments are presented by way of example only and that, within the scope of the appended claims and equivalents thereto, the invention may be practiced otherwise than as specifically described.

For example, more than one gantry assembly and more than one powder dispenser assembly may be supported by the side rails, and more than one carriage can be included on each gantry assembly so that a plurality of parts can be manufactured on the build table simultaneously. Further, the powder dispenser assembly can be designed so that the powder supply duct travels with the gantry assembly at all times to continuously supply the trough with build material. As another example, rather than making separate passes along the x-axis to deposit the build material and the binding material, a single pass can be used to deposit both the build material and the binding material.

In addition, the overall size and configuration of the system 10 and its various components can be sized and configured to suit a particular application. A system in accordance with the invention can produce parts of essentially any size. In addition, the system 10 could be sized and configured at the time of installation and/or could be mounted on wheels for portability.

1. An apparatus for fabricating a three-dimensional object from a representation of the object stored in memory, the apparatus comprising:
a stationary build table for receiving successive layers of a build material; and
at least one printhead disposed above the build table for selectively applying binder.

2. The apparatus of claim 1 further comprising means for supplying powdered build material to the build table.

3. The apparatus of claim 1 further comprising means for positioning the at least one printhead in a three dimensional space above the build table.

4. The apparatus of claim 1 further comprising an enclosure disposed about the stationary build table.

5. The apparatus of claim 4 further comprising an air handling system, the air handling system comprising:
at least one air intake port disposed through a wall of the enclosure; and
an exhaust system in communication with an interior area of the enclosure for drawing air out of the enclosure.

6. The apparatus of claim 5, wherein the air handling system further comprises filtration means.

7. The apparatus of claim 1 further comprising a build material delivery system comprising:
a storage means for holding the build material; and
a conveying means for delivering the build material to the build table.

8. The apparatus of claim 7 further comprising:
at least two storage chambers for holding at least two build material components separate from each other; and
a blender for mixing the build material components in a predetermined ratio for delivery to the build table.

9. The apparatus of claim 1 further comprising a build material dispensing system, the system comprising:
a trough for receiving the build material, the trough mounted on a gantry capable of traversing at least a portion of the build table; and
metering means for dispensing the build material.

10. The apparatus of claim 9, wherein a delivery dimension of the build material dispensing system is adjustable to correspond to a width of a predetermined build volume.

11. The apparatus of claim 9 further comprising spreading means for distributing the dispensed build material evenly to form a layer.

12. The apparatus of claim 1 1, wherein the spreading means comprises a range of travel adjustable to correspond to a length of a predetermined build volume.

13. The apparatus of claim 11 further comprising a sensor for determining an amount of build material deposited in each layer.

14. The apparatus of claim 9, wherein the dispensing system further comprises a translating nozzle for delivering the build material to the trough.

15. The apparatus of claim 9 further comprising a sensor for measuring the distribution of build material in the trough.

16. The apparatus of claim 3, wherein the printhead is mounted in a carrier, the carrier being mounted in a carriage.

17. The apparatus of claim 16, wherein the carrier engages mechanical, electrical, and fluid interfaces of the printhead.

18. The apparatus of claim 16, wherein the carrier engages mechanical, electrical, and fluid interfaces of the carriage.

19. The apparatus of claim 16 further comprising a printhead stable capable of housing at least one spare printhead, the stable comprising means for interchanging printheads for use with the apparatus.

20. The apparatus of claim 16 further comprising a printhead reconditioning station for performing printhead maintenance.

21. The apparatus of claim 16 further comprising a carrier transfer means for transferring the printhead between the carriage and the stable.

22. The apparatus of claim 1 further comprising printhead reconditioning means.

23. The apparatus of claim 3 further comprising means for moving the printhead in a vertical direction, the means comprising at least one jack post for supporting the gantry, the jack post including a lead screw, a lead screw nut, and a motor for driving the lead screw.

24. The apparatus of claim 23 further comprising an encoder for determining a position of the lead screw nut.

25. The apparatus of claim 3 further comprising a gantry for moving the printhead in a first horizontal direction.

26. The apparatus of claim 25, wherein the gantry is positioned in the first horizontal position by at least one of at least one motor-driven belt and at least one motor-driven lead screw.

27. (canceled)

28. The apparatus of claim 3 further comprising a carriage for moving the printhead in a second horizontal direction.

29. The apparatus of claim 28, wherein the carriage is positioned in the second horizontal position by at least one of at least one motor-driven belt and at least one motor-driven lead screw.

30. (canceled)

31. A method of fabricating a three-dimensional object comprising the steps of:
depositing successive layers of a build material on a stationary build table; and
depositing a liquid in a predetermined pattern on each successive layer of the build material to form the three-dimensional object.

32. The method of claim 31 further comprising the step of:
circumscribing the three-dimensional object with additional liquid to form a wall about the three-dimensional object.

33. The method of claim 32, wherein the wall and the table define a build volume.

34.-43. (canceled)

44. An apparatus for reconditioning a printhead, the apparatus comprising:
a nozzle array for spraying a washing solution towards a face of a printhead; and
a wicking member disposed in proximity to the printhead face for removing excess washing solution from the printhead face.

45.-53. (canceled)

54. A method of reconditioning a printhead, the method comprising the steps of:
positioning a face of the printhead relative to at least one nozzle;
operating the at least one nozzle to spray washing solution towards the printhead face; and
removing excess washing solution from the printhead face by passing a wicking member in close proximity to the printhead face, without contacting the printhead face.

55.-58. (canceled)
